(19) United States
(12) Patent Application Publication
(10) Pub. No.: US 2026/0049209 A1
(43) Pub. Date: Feb. 19, 2026

(54) Curable Polymer Composition Having Improved Wash-Off Resistance

(71) Applicant: Zephyros, Inc., Romeo, MI (US)

(72) Inventors: Laurent Meistermann, Molsheim Cedex (FR); Thomas Pedrollo, Mlosheim Cedex (FR)

(21) Appl. No.: 19/103,573

(22) PCT Filed: Sep. 4, 2023
(86) PCT No.: PCT/EP2023/074163

§ 371 Date: Feb. 13, 2025

(30) Foreign Application Priority Data
Sep. 5, 2022 (EP) 22193932.5
Mar. 14, 2023 (EP) 23161799.4

(51) Int. Cl. C08L 23/0869; C08J 9/00; C08K 3/34; C08L 63/00; C09J 11/04; C09J 123/08; C09J 163/00

(52) U.S. Cl. CPC C08L 23/0869; C08J 9/0061; C08J 9/0066; C08L 63/00; C09J 11/04; C09J 123/0869; C09J 163/00; C08J 2323/08; C08J 2423/08; C08J 2425/02; C08J 2433/08; C08J 2435/02; C08K 2003/343; C08L 2203/14; C08L 2205/025; C08L 2205/035

(57) ABSTRACT

The invention relates to a curable and preferably polymer composition that is useful as a sealant, an adhesive (e.g., structural adhesive), a reinforcement, a dampener, a sound absorber or any combination thereof. The composition preferably comprises one or more ethylene polymers, tackifier, curing agent, and rheology modifier. The invention also relates to extrusion of the composition onto an article surface, e.g. through a robotically mounted extrusion die, and subsequent activation for curing by an external stimulus.

Priority is claimed of European patent application no. 22 193 932.5 that was filed on Sep. 5, 2022 and of European patent application no. 23 161 799.4 that was filed on Mar. 14, 2023.

The invention relates to a curable and preferably pumpable polymer composition that is useful as a sealant, an adhesive (e.g., structural adhesive), a reinforcement, a dampener, a sound absorber or any combination thereof. The composition preferably comprises one or more ethylene polymers, tackifier, curing agent, and rheology modifier. The invention also relates to extrusion of the composition onto an article surface, e.g. through a robotically mounted extrusion die, and subsequent activation for curing by an external stimulus. The composition is particularly useful for application by extrusion in place.

In a conventional manufacturing process of automobiles, in a first step, a curable and pumpable adhesive is applied to the surface of a substrate of a vehicle in its uncured state e.g. by means of a robot, optionally at intermediate temperatures that are not high enough to induce curing (extrusion temperature). In a second step, the substrate may be assembled with a counter substrate and mechanically fastened or welded along a bond line to lock the two substrates in place. The curable and pumpable adhesive is then located as a film, strip, or the like between the substrate to which it has been applied and the counter substrate. In a third step, the vehicle body with the mechanically fastened or welded substrates is subjected to a series of sprays and baths for cleaning purposes, i.e. to remove oil and/or dirt, and/or for anti-corrosion purposes, i.e. to apply suitable coatings for corrosion prevention (e-coat). In a fourth step, the thus treated and coated vehicle body is subjected to high temperatures in a bake oven which induce curing of the adhesive (curing temperature) thereby adhering the two substrates to one another.

Thus, a curable and pumpable adhesive needs to satisfy certain requirements with respect to rheology at different temperatures and also with respect to resistance against wash-off. At low temperatures a curable and pumpable adhesive should have good pumpability. At intermediate temperatures a curable and pumpable adhesive should have the appropriate rheology to prevent wash-off but should not cure prematurely. In its uncured state, the curable and pumpable adhesive needs to tolerate the intermediate temperature without curing, and to withstand the subsequent exposure to high volumes of water and other liquids during the third step. If the curable and pumpable adhesive fails to withstand the above conditions, it will wash-off the vehicle body during the third step. The washed-off material not only contaminates the baths, but is often redeposited onto the surface of the vehicle body in a different area where it is not desired, e.g. because this would cause paint defects. At high temperatures the curable and pumpable adhesive, which may be regarded as a thermoplastic material prior to and while it is being applied to an article, e.g., prior to curing) should cure thereby becoming a thermoset material.

Such rheological profile is difficult to achieve, because viscosity of most liquids strongly de-pends upon temperature and typically exponentially increases as temperature decreases (Andrade equa-tion, μ=Ae^{B/T}).

As several conventional curable and pumpable adhesives do not pass the wash-off test, it has been suggested to improve wash-off resistance by means of a precuring step, which is typically achieved by heating the assemblies for about 15 minutes at a temperature of about 160° C., before they are subjected to spraying and coating steps, i.e. exposed to liquids. Precuring does not finally cure the adhesive but causes an increase of viscosity due to partial curing thereby improving wash-off resistance. However, such precuring is disadvantageous because it requires an additional treatment step, extends time of manufacture, and consumes additional energy. Further, it is difficult to control the degree of curing, as the material should maintain residual curability when it will finally be exposed to high temperatures again (curing temperature). Further, when the material is expandable, it is difficult to avoid premature volume expansion during precuring (activation temperature). Thus, it would be desirable to provide curable and pumpable adhesives that pass the wash-off test without requiring preceding precuring.

Further problems arise when the surface of the substrate, e.g. metal and/or polymeric panel or other article (e.g., a carrier for a baffle and/or structural reinforcement), to which the curable and pumpable adhesive is applied is oily or contains some other surface contaminant. The oil or other contaminant may have a negative impact on adhesion of the uncured adhesive and thus deteriorate its wash-off resistance. It would thus be desirable to provide curable and pumpable adhesives that can tolerate oily or other contaminated surfaces while maintaining wash-off resistance and also providing satisfactory adhesive properties after curing. Some conventional curable and pumpable adhesives provide satisfactory adhesion to oily or other contaminant-containing surfaces of substrates only when the substrates are heated to temperatures of typically more than 70° C. (substrate temperature). It would be desirable to provide curable and pumpable adhesives that provide satisfactory adhesion to oily or otherwise contaminated surfaces of substrates, e.g. metal and or polymeric panels, without requiring heating the substrates, or merely requiring heating the substrates to lower temperatures of e.g. less than 55° C. (substrate temperature). It would be desirable to provide curable and pumpable adhesives that provide satisfactory adhesion to oily or otherwise contaminated surfaces of substrates in a process that is free of any surface treatment step for the substrate (e.g., the process excludes any step of plasma treatment, flame spray, heating above 55° C. or the like).

Particular problems may arise when the substrates to which the curable and pumpable adhesives have been applied are not assembled with a counter substrate before they are subjected to a series of sprays and baths. Under these circumstances, the applied curable and pumpable adhesives are not pro-tected by a sandwich assembly (i.e. at the interface between substrate and counter substrate), but instead on one side are fully exposed to the bath liquids due to the missing counter substrate. Situations where a counter substrate is missing are relevant in vehicle manufacture, e.g. when the curable and pumpable adhesive is volume expandable upon heat activation in order to fill a cavity. The curable and pumpable adhesive is then applied to the inner surface of a substrate that forms/surrounds the cavity, but no counter substrate is applied thereon. Once the assembly is subjected to high temperature (curing temperature), the curable and pumpable adhesive cures and simultaneously expands its volume (activation temperature) thereby filling the cavity. As a consequence of volume expansion, the adhesive material comes into contact with the opposite side of the cavity and adheres thereto. In the intermediate state, i.e. prior to any expansion and/or curing, however, the applied curable and pumpable adhesive is fully exposed to bath liquids when the assembly is subjected to corresponding treatment steps. Other relevant applications with or without a counter substrate (and to which the subject of the present teachings is directed) include but are not limited to lower or upper outer section of A pillar, lower or upper outer section of B pillar, lower or upper outer section of C pillar, lower or upper outer section of D pillar, rails, roof bows, cross-beams, battery supports, battery frames, one or more junctions between reinforcements and/or baffles and another vehicle component (e.g., exterior skins, doors or other closures, roof, hoods, floors, truck beds, and trunks. For the above, under some conditions, e.g., in the absence of a counter substrate, it is significantly more difficult to achieve wash-off resistance.

EP 1 331 080 A2 relates to methods for applying melt flowable materials to components of articles of manufacture. The methods are concerned with formation of appropriate flowable materials, control over the manner in which the flowable materials are applied, treatment of the components prior to application of the flowable materials and the like. Moreover, the methods may be particularly suited for applying flowable materials to surfaces and components found in automotive, aerospace, and marine vehicles.

EP 3 281 970 A1 relates to a pumpable thermally foaming filler composition and in particular relates to a pumpable thermally foaming filler composition which is suitable for forming an insulation material for blocking noise during the operation of a vehicle when charged into closed sections of vehicle body members such as a pillar of a vehicle and then foamed by the heat of a baking process.

U.S. Pat. No. 9,987,785 relates to methods and apparatuses for applying activatable melt flowable materials to substrates made from synthetic materials. The methods are concerned with formation of appropriate flowable materials, control over the manner in which the flowable materials are applied, treatment of the substrates prior to application of the flowable materials and the selection of the optimum combination of materials for the substrates and the flowable materials. The methods may be particularly suited for applying flowable materials to surfaces to produce components found in automotive, aerospace including trucks, busses and tractors and marine vehicles.

US 2006 0127584 relates to methods and apparatuses for applying melt flowable materials to components of articles of manufacture. The methods and apparatuses are concerned with formation of appropriate flowable materials, control over the manner in which the flowable materials are applied, treatment of the components prior to application of the flowable materials and the like.

WO 2004/076507 A2 relates to a reactive hot melt composition in the form of free-flowing pellets. The composition comprises from 37 to 60% based on the total weight of the composition of a cross-linkable resin including at least one copolymer of ethylene with an ethylenically unsaturated monomer and wherein the cross-linkable resin includes an ethylene-acrylic acid or ethylene-methacrylic acid copolymer, from 10 to 30% based on the total weight of the composition of an adhesion promoter, which is a plasticizer and/or a tackifier, for providing adhesive properties to the composition at temperatures of from 50 to 100° C., from 0.5 to 3% based on the total weight of the composition of a free radical cross-linking initiator having a 1 hour half-life temperature of from 110 to 170° C., from 10 to 40% based on the total weight of the composition of a filler and from 0.1 to 4% based on the total weight of the composition of a foaming agent.

WO 2008 045270 A1 and WO 2009 058295 A2 relate to heat curable epoxy-based compositions. The compositions are said to be pumpable and resistant to being washed off substrate surfaces prior to being cured.

WO 2010 023324 A1 relates to a reinforcer that includes a carrier conforming generally to one or more inner walls of a cavity, and an adhesive arranged in one or more beads between the carrier and the one or more inner walls of the cavity, such that when the one or more adhesive beads is cured, the carrier is adhered to the one or more inner walls defining the cavity.

WO 2012 041513 A1 relates to a foamable adhesive system which can achieve necessary adhesion to an oily surface and which is not tacky to the touch once applied to the surface and has a melt viscosity in the bake phase high enough to retain its shape and adhesion to the substrate and in addition a melt viscosity sufficiently high to retain gas bubbles formed by the decomposition of the blowing agent and which also retains its shape and structure once formed by use of a polymer system containing a thixotropic filler and a two compartment (component) cross linking system.

WO 2012 104071 A2 relates to the extrusion of thermohardenable materials by cooling the material in the initial zone of the extruder and reducing residence time by use of a prescribed length to diameter ratio and screw speed, particularly useful for intermittent application during robotically controlled mass production.

WO 2014 108857 A1 relates to an extrusion process and apparatus for the deposition of precise, usually small amounts of extrudate for adhesion to a substrate comprising an extruder positioned close to the substrate and a jet of hot gas directed onto the extrudate between the extruder and the substrate in order to retain the adhesive properties between the extrudate and the substrate.

WO 2014 124924 A1 relates to a process for making a reinforced structural member, in particular forming part of an automobile or other vehicle or an airplane or a ship, the reinforced structural member comprising an original structural member and a reinforcing carrier and an adhesive bead and/or a plurality of adhesive plots arranged between an outer surface of the reinforcing carrier and a contact surface of the original structural member, for structurally bonding the reinforcing carrier to the original structural member.

US 2018 0273804 relates to applying heat activatable adhesive to a substrate, the adhesive is solid at ambient temperature and can be melted at a temperature below its heat activation temperature wherein the adhesive formulation is supplied to a hot melt applicator where it is heated to above its melting point and below its activation temperature and the melt viscosity of the molten adhesive is controlled so that it can be ejected from the hot melt applicator onto a substrate to provide a coherent bead that adheres to the substrate and is dry to the touch on cooling and upon activation the adhesive is capable of expanding with a volume expansion greater than about 250%.

WO 2019/079026 A1 relates to an epoxy-based crash durable adhesive composition including: (I) a liquid resin system comprising: (a) at least one epoxy resin; and (b) at least one toughener; wherein the viscosity of the above liquid resin system is less than about 800 Pa·s at a temperature of 15° C.; and wherein the viscosity of the above liquid resin system is greater than about 5 Pa·s at a temperature of 60° C.; (II) a solid material comprising: (c) at least one hydrophobic fumed silica, wherein the fumed silica is present in the adhesive composition at a concentration of greater than 5 weight percent; and (III) a curative material comprising: (d) at least one latent heat-activated curing agent; wherein the rheology of the epoxy-based crash durable adhesive composition is such that the adhesive composition is pumpable at a temperature of 15° C. or greater; and wherein the epoxy-based crash durable adhesive composition exhibits an increase in wash-off resistance.

WO 2020 212211 A1 relates to a heat curable composition that includes a peroxidically cross-linkable polymer and at least one liquid polymer.

WO 2022/162058 A1 relates to the field of structural reinforcement, sealing, damping, baffling, or the like of elements, preferably of hollow structures or cavities, by means of a thermally expandable composition comprising (i) a polymer component; (ii) azodicarbonamide; and (iii) a metal oxide powder capable of catalyzing thermal decomposition of azodicarbonamide at elevated temperature, wherein at least about 90 wt.-% of particles within the metal oxide powder have a particle size of at most about 200 μm determined by sieve analysis; wherein the weight ratio of the azodicarbonamide to the metal oxide powder is at least about 5.0.

The properties of the curable and pumpable adhesives of the prior art is not satisfactory in every respect and there is a demand for improved curable and pumpable adhesives. The known curable and pumpable adhesives do not provide an acceptable wash-off resistance and are not pumpable at low temperatures. Therefore, there is a demand for curable and pumpable adhesives having improved wash-off resistance while maintaining the rheological requirements for pumpability at low temperatures.

It is an object of the invention to provide a curable polymer composition for use as sealant, adhesive, reinforcement, dampener, and/or a sound absorber that have advantages compared to the prior art.

The polymer compositions should be pumpable, e.g. extrudable, optionally at elevated temperature (extrusion temperature), and wash-off resistant. The polymer compositions should be processable at comparatively low temperatures thereby reducing the overall energy consumption of processing. For certain purposes, the curable polymer composition should be expandable. It should be possible to apply the curable polymer compositions onto oily surfaces of substrates, e.g. metal panels, at moderate temperatures while achieving wash-off resistance. Wash-off resistance should even be achieved in cases where the compositions are applied on surfaces of substrates without counter substrates such that upon subjecting the assemblies with the compositions applied thereon to sprays and baths, the applied compositions are fully exposed to the liquids.

This object has been achieved by the subject-matter of the patent claims.

It has been surprisingly found that by combining the right polymers (resin blend) having suitable viscosity and melting temperature (preferably a combination of first ethylene copolymer, second ethylene copolymer, and ethylene terpolymer); and by using a right amount of rheology modifier (preferably one or more phyllosilicates); it is possible to extrude the resultant curable polymer composition on an oily substrate, e.g. metal panel, moderately heated (<55° C., substrate temperature) while maintaining the composition wash-off resistance even when the test is performed under harsh conditions, i.e. when no counter substrate is used for the wash-off resistance test.

Further, it has been found that the curable and preferably pumpable polymer composition according to the invention can be used in automated processes, e.g. can be applied robotically, and requires no specific tooling.

Still further, it has been surprisingly found that the curable and preferably pumpable polymer composition according to the invention does not require a precuring step in order to provide satisfactory wash-off resistance. This improves energy efficiency and has further economical advantages.

Yet further, it has been surprisingly found that a curable polymer composition can be used for replacing parts that are conventionally used for corresponding purposes in automotive manufacture such as baffles, preferably for gaps between two substrates to be adhered to one another of 70 mm or less, preferably 50 mm or less, and more preferably 20 mm or less. Using the curable and preferably pumpable polymer composition according to the invention instead of conventional baffles is cost effective, adaptable to various designs of substrates to be adhered to one another, and does not need any additional equipment or tools.

The curable polymer composition according to the invention combines optimized chemistry with the capability of a fully automated application process. The composition may be extruded and applied directly onto a substrate by robotic application. The composition offers good wash-off resistance and is preferably formulated to be dry-to-the-touch immediately after being extruded onto the substrate, which leads to improved handling and enables to stack or nest several parts, resulting in minimized packaging costs. The curable polymer composition according to the invention is preferably dry-to-touch and preferably provides versatile design capability, superior green state adhesion and good wash-off resistance. It offers a high level of repeatability for applications of varying complexity, improved acoustic and sealing performance, improved handling, and minimized packaging costs. The composition provides Superior uncured state adhesion to a wide range of substrates and adheres to most substrates while improving acoustic and sealing performance.

When desirable, the curable polymer composition according to the invention may provide high volume expansion over a broad temperature range. It is ideal for long, narrow gaps and cavities and preferably allows for cold application with conventional pumping equipment. It eliminates tooling costs, can be automatically applied, and provides flexibility after body design changes. It can be used as a pumpable baffle that is applicable in the automotive body shop and is ideal for automated application in areas requiring a narrow cavity or gap filling. Once cured, it offers excellent adhesion to oily and e-coated body panels, including all of the main substrates used in the automotive industry—cold-rolled, galvanized (hot dipped and electroplated) and galvanneal steel, as well as automotive grades of aluminum. the curable polymer composition according to the invention also maintains its adhesion properties through a range of aging and weathering test conditions.

A first aspect of the invention relates to a curable and preferably pumpable polymer composition for use as a sealant, an adhesive, a reinforcement, a dampener, and/or a sound absorber,
(a) wherein the composition can be deposited onto a surface of an article, preferably a vehicle component, by extrusion at ambient temperature (about 23° C.) or at an elevated temperature (e.g. about 120° C.) without premature curing (extrusion temperature); wherein following deposition the composition can be bathed in a liquid coating fluid, preferably an electrocoating bath, without being washed off, preferably without preceding precuring; and wherein following bathing the composition can be activated for curing by an external stimulus (curing temperature);
   and/or
(b) wherein the composition comprises or essentially consists of
   one or more olefin (e.g., ethylene) polymers, preferably
      (i) first ethylene copolymer,
      (ii) second ethylene copolymer, and
      (iii) ethylene terpolymer;
   (iv) tackifier;
   (v) curing agent;
   (vi) optionally, blowing agent;
   (vii) rheology modifier; preferably one or more phyllosilicates;
   (viii) optionally, blowing agent accelerator;
   (ix) optionally, polymerization initiator;
   (x) optionally, filler (e.g., calcium carbonate, a metallic oxide, graphite (e.g., graphite flakes), a clay, a silicon-containing compound other than a phyllosilicate, an aramid pulp, or the like); and
   (xi) optionally, coloring agent.

The curable and preferably pumpable polymer composition may have property (a) but not property (b), or property (b) but not property (a), or both properties (a) and (b).

For the purpose of the specification, “pumpable” means that at room temperature (23° C.) the composition can be pumped by means of equipment conventionally used for applying adhesive compositions onto surfaces of substrates. Pumping pressures are typically not more than 50 bars, more preferably not more than 20 bars. For the purpose of the specification, “pumpable” includes “extrudable”, whereas “extrudable” means that at room temperature (23° C.) the composition can be extruded by conventional extruders. It is also possible that compositions in accordance with the present teachings can be pumpable or extrudable at temperatures above room temperature (e.g., above 23° C., preferably above 75° C., or even above 150° C.) but below any temperature of activation of any of the ingredients.

The curable and preferably pumpable polymer composition according to the invention preferably comprises one or more olefin polymers, and preferably ethylene polymers, i.e. homopolymers, copolymers, or terpolymers derived from ethylene as monomer and comonomer, respectively.

The curable and preferably pumpable polymer composition according to the invention preferably comprises first ethylene copolymer, which preferably comprises or essentially consists of one or more ethylene/butyl acrylate copolymers. When the first ethylene copolymer comprises more than a single polymer, e.g. two different ethylene/butyl acrylate copolymers, unless expressly stated otherwise, all amounts refer to the total content of all polymers that are encompassed by the first ethylene copolymer.

Preferably, the first ethylene copolymer excludes any copolymer having a melt index according to ISO 1133 (190° C./2.16 kg) above 450 g/10 min, preferably above 350 g/10 min.

Preferably, at least 40 wt.-%, preferably at least 45 wt.-%, of the first ethylene copolymer, relative to the total content of the first ethylene copolymer, has a melt index according to ISO 1133 (190° C./2.16 kg) below 50 g/10 min. Thus, when the first ethylene copolymer comprises a mixture of two or more different polymers, a quantified portion thereof is characterized by the stated property.

Suitable first ethylene copolymers, e.g. ethylene/butyl acrylate copolymers, are commercially available, e.g. as Lotryl® 35BA320 and/or Lotryl® 35BA40.

Preferably, the content of first ethylene copolymer is within the range of 45±40 wt.-%, preferably 45±35 wt.-%, more preferably 45±30 wt.-%, still more preferably 45±25 wt.-%, yet more preferably 45±20 wt.-%, even more preferably 45±15 wt.-%, most preferably 45±10 wt.-%, and in particular 45±5.0 wt.-%, in each case relative to the total weight of the composition.

Preferably, the first ethylene copolymer comprises or essentially consists of a mixture of
an ethylene/butyl acrylate copolymer A having a melt index according to ISO 1133 (190° C./2.16 kg) within the range of 300±275 g/10 min, preferably 300±250 g/10 min, more preferably 300±225 g/10 min, still more preferably 300±200 g/10 min, yet more preferably 300±175 g/10 min, even more preferably 300±150 g/10 min, most preferably 300±100 g/10 min, and in particular 300±50 g/10 min; and
an ethylene/butyl acrylate copolymer B having a melt index according to ISO 1133 (190° C./2.16 kg) within the range of 40±37.5 g/10 min, preferably 40±35 g/10 min, more preferably 40±30 g/10 min, still more preferably 40±25 g/10 min, yet more preferably 40±20 g/10 min, even more preferably 40±15 g/10 min, most preferably 40±10 g/10 min, and in particular 40±5.0 g/10 min.

Preferably, the first ethylene copolymer comprises or essentially consists of a mixture of
an ethylene/butyl acrylate copolymer A at a content within the range of 22.5±20.0 wt.-%, preferably 22.5±17.5 wt.-%, more preferably 22.5±15.0 wt.-%, still more preferably 22.5±12.5 wt.-%, yet more preferably 22.5±10.0 wt.-%, even more preferably 22.5±7.5 wt.-%, most preferably 22.5±5.0 wt.-%, and in particular 22.5±2.5 wt.-%, in each case relative to the total weight of the composition; and
an ethylene/butyl acrylate copolymer B at a content within the range of 22.5±20.0 wt.-%, preferably 22.5±17.5 wt.-%, more preferably 22.5±15.0 wt.-%, still more preferably 22.5±12.5 wt.-%, yet more preferably 22.5±10.0 wt.-%, even more preferably 22.5±7.5 wt.-%, most preferably 22.5±5.0 wt.-%, and in particular 22.5±2.5 wt.-%, in each case relative to the total weight of the composition.

The curable and preferably pumpable polymer composition according to the invention preferably comprises second ethylene copolymer, which preferably comprises or essentially consists of one or more ethylene/vinyl acetate copolymers. When the second ethylene copolymer comprises more than a single polymer, e.g. two different ethylene/vinyl acetate copolymers, unless expressly stated otherwise, all amounts refer to the total content of all polymers that are encompassed by the second ethylene copolymer.

Preferably, the second ethylene copolymer excludes any copolymer having a melt index according to ISO 1133 (190° C./2.16 kg) above 1000 g/min, preferably above 900 g/10 min.

Preferably, at least 40 wt.-%, preferably at least 45 wt.-%, of the second ethylene copolymer, relative to the total content of the second ethylene copolymer, has a melt index according to ISO 1133 (190° C./2.16 kg) below 50 g/10 min. Thus, when the second ethylene copolymer comprises a mixture of two or more different polymers, a quantified portion thereof is characterized by the stated property.

Suitable second ethylene copolymers, e.g. ethylene/vinyl acetate copolymers, are commercially available, e.g. as Evatane® 28-800, Evatane® 2805 or Escorene® UL 7760.

Preferably, the content of second ethylene copolymer is within the range of 7.5±7.0 wt.-%, preferably 7.5±6.5 wt.-%, more preferably 7.5±6.0 wt.-%, still more preferably 7.5±5.5 wt.-%, yet more preferably 7.5±5.0 wt.-%, even more preferably 7.5±4.5 wt.-%, most preferably 7.5±4.0 wt.-%, and in particular 7.5±3.5 wt.-%, in each case relative to the total weight of the composition.

Preferably, the second ethylene copolymer comprises or essentially consists of a mixture of
an ethylene/vinyl acetate copolymer C having a melt index according to ISO 1133 (190° C./2.16 kg) within the range of 800±750 g/10 min, preferably 800±700 g/10 min, more preferably 800±600 g/10 min, still more preferably 800±500 g/10 min, yet more preferably 800±400 g/10 min, even more preferably 800±300 g/10 min, most preferably 800±200 g/10 min, and in particular 800±100 g/10 min; and
an ethylene/vinyl acetate copolymer D having a melt index according to ISO 1133 (190° C./2.16 kg) within the range of 6.5±5.0 g/10 min, preferably 6.5±4.5 g/10 min, more preferably 6.5±30 g/4.0 min, still more preferably 6.5±3.5 g/10 min, yet more preferably 6.5±3.0 g/10 min, even more preferably 6.5±2.5 g/10 min, most preferably 6.5±2.0 g/10 min, and in particular 6.5±1.5 g/10 min.

Preferably, the second ethylene copolymer comprises or essentially consists of a mixture of
an ethylene/vinyl acetate copolymer C at a content within the range of 3.75±3.50 wt.-%, preferably 3.75±3.25 wt.-%, more preferably 3.75±3.00 wt.-%, still more preferably 3.75±2.50 wt.-%, yet more preferably 3.75±2.00 wt.-%, even more preferably 3.75±1.50 wt.-%, most preferably 3.75±1.00 wt.-%, and in particular 3.75±0.50 wt.-%, in each case relative to the total weight of the composition; and
an ethylene/vinyl acetate copolymer D at a content within the range of 3.75±3.50 wt.-%, preferably 3.75±3.25 wt.-%, more preferably 3.75±3.00 wt.-%, still more preferably 3.75±2.50 wt.-%, yet more preferably 3.75±2.00 wt.-%, even more preferably 3.75±1.50 wt.-%, most preferably 3.75±1.00 wt.-%, and in particular 3.75±0.50 wt.-%, in each case relative to the total weight of the composition.

The curable and preferably pumpable polymer composition according to the invention preferably comprises ethylene terpolymer, which preferably comprises or essentially consists of one or more reactive ethylene terpolymers. When the ethylene terpolymer comprises more than a single polymer, e.g. two different ethylene terpolymers, unless expressly stated otherwise, all amounts refer to the total content of all polymers that are encompassed by the ethylene terpolymer.

Preferably, the ethylene terpolymer comprises or essentially consists of one or more reactive elastomeric ethylene terpolymers.

Preferably, the ethylene terpolymer comprises or essentially consists of one or more butyl acry-late/glycidyl methacrylate/ethylene terpolymers.

Preferably, at least 40 wt.-%, preferably at least 45 wt.-%, of the ethylene terpolymer, relative to the total content of the ethylene terpolymer, has a melt index according to ISO 1133 (190° C./2.16 kg) below 50 g/10 min. Thus, when the ethylene terpolymer comprises a mixture of two or more different polymers, a quantified portion thereof is characterized by the stated property.

Preferably, the ethylene terpolymer excludes any terpolymer having a melt index according to ISO 1133 (190° C./2.16 kg) above 50 g/10 min, preferably above 10 g/10 min.

Preferably, the ethylene terpolymer has a melt index according to ISO 1133 (190° C./2.16 kg) within the range of 8.0±5.0 g/10 min, preferably 8.0±4.5 g/10 min, more preferably 8.0±30 g/4.0 min, still more preferably 8.0±3.5 g/10 min, yet more preferably 8.0±3.0 g/10 min, even more preferably 8.0±2.5 g/10 min, most preferably 8.0±2.0 g/10 min, and in particular 8.0±1.5 g/10 min.

Suitable ethylene terpolymers, e.g. n-butyl acrylate/glycidyl methacrylate/ethylene terpolymers, are commercially available, e.g. as Elvaloy® 4170.

Preferably, the content of ethylene terpolymer is within the range of 4.5±4.0 wt.-%, preferably 4.5±3.5 wt.-%, more preferably 4.5±3.0 wt.-%, still more preferably 4.5±2.5 wt.-%, yet more preferably 4.5±2.0 wt.-%, even more preferably 4.5±1.5 wt.-%, most preferably 4.5±1.0 wt.-%, and in particular 4.5±0.5 wt.-%, in each case relative to the total weight of the composition.

The curable and preferably pumpable polymer composition according to the invention preferably comprises tackifier. When the tackifier comprises more than a single tackifier, e.g. two different tackifiers, unless expressly stated otherwise, all amounts refer to the total content of all tackifiers that are encompassed by the tackifier.

Preferably, the tackifier comprises or essentially consists of one or more hydrocarbon tackifier resins.

Preferably, the tackifier comprises or essentially consists of one or more polymerization products from unsaturated aromatic C9-/C10-hydrocarbons.

Suitable tackifiers, e.g. hydrocarbon resins; polymerization product from unsaturated aromatic C9-/C10-hydrocarbons are commercially available, e.g. as Novares® TD100.

Preferably, neither the tackifier nor the composition contains a hydroxylated polyester tackifier resin; preferably neither the tackifier nor the composition contains any polyester tackifier resin.

Preferably, the content of tackifier, preferably one or more polymerization products from unsaturated aromatic C9-/C10-hydrocarbons, is more than 8.0 wt.-%, preferably at least 9.0 wt.-%, more preferably at least 10 wt.-%, still more preferably at least 11 wt.-%, yet more preferably at least 12 wt.-%, even more preferably at least 13 wt.-%, most preferably more than 14 wt.-%, in each case relative to the total weight of the composition.

Preferably, the content of tackifier, preferably one or more polymerization products from unsaturated aromatic C9-/C10-hydrocarbons, is less than 16 wt.-%, relative to the total weight of the composition.

The curable and preferably pumpable polymer composition according to the invention preferably comprises curing agent. When the curing agent comprises more than a single curing agent, e.g. two different curing agents, unless expressly stated otherwise, all amounts refer to the total content of all curing agents that are encompassed by the curing agent.

The curing agent is capable of reacting with itself and/or with other constituents of the composition according to the invention thereby achieving crosslinking and curing. Preferably, the curing agent is capable of reacting with the one or more ethylene polymers, e.g. with the first ethylene copolymer, with the second ethylene copolymer, with the ethylene terpolymer, or with any combination thereof.

The curing reaction is preferably induced by a radical polymerization initiator, preferably a per-oxide, that is activatable at elevated temperature (curing temperature).

Preferably, the curing agent comprises or essentially consists of dipentaerythritol pentaacrylate, dipentaerythritol hexaacrylate, pentaerythritol tetraacrylate, 1,4-butanediol diacrylate, trimethylolpro-pane triacrylate, tripropyleneglycol diacrylate, diethyleneglycol diacrylate, or mixtures thereof, partic-ularly preferable dipentaerythritol pentaacrylate.

Suitable curing agents, e.g. dipentaerythritol pentaacrylate, are commercially available, e.g. as SR399.

Preferably, the content of curing agent, preferably dipentaerythritol pentaacrylate, is at most 1.45 wt.-%, preferably at most 1.40 wt.-%, still more preferably at most 1.35 wt.-%, yet more preferably at most 1.30 wt.-%, even more preferably at most 1.25 wt.-%, most preferably at most 1.20 wt.-%, in each case relative to the total weight of the composition.

In preferred embodiments, the composition according to the invention cures at elevated temperature (curing temperature), preferably at a temperature of at least at least 110° C., more preferably at least 120° C., still more preferably at least 130° C., yet more preferably at least 140° C., even more preferably at least 150° C., most preferably at least 160° C., and in particular at least 170° C.

In preferred embodiments, the composition according to the invention cures at elevated temperature (curing temperature), preferably at a temperature of at most 200° C., more preferably at most 195° C., still more preferably at most 190° C., yet more preferably at most 185° C., even more preferably at most 180° C., most preferably at most 175° C., and in particular at most 170° C.

The curable and preferably pumpable polymer composition according to the invention is preferably expandable (i.e. capable of expanding its volume after activation). For that purpose, the curable and preferably pumpable polymer composition according to the invention preferably comprises blowing agent. When the blowing agent comprises more than a single blowing agent, e.g. two different blowing agents, unless expressly stated otherwise, all amounts refer to the total content of all blowing agents that are encompassed by the blowing agent.

Preferably, the blowing agent comprises or essentially consists of one or more chemical blowing agents. The chemical blowing agent may be exothermic or endothermic. It is possible, however, that the composition may include one or more physical blowing agents (e.g., it may include a thermoplastic microsphere encapsulating a gas, pursuant to which, after being heated, the gas expands and the shell softens thereby increasing its volume; a commercial example of which includes those marketed under the name Expancel®).

Preferably, the blowing agent comprises or essentially consists of azodicarbonamide, dinitro-sopentamethylenetetramine, dinitroso-pentamethylenetetramine, 4,4′oxy-bis-(benzene-sulphonylhy-drazide), trihydrazinotriazine and N,N′-dimethyl-N,N′-dinitroso-terephthalamide; particularly preferably azodicarbonamide. Other blowing agents may include a metal carbonate (e.g., sodium bicarbonate) alone or in combination with another blowing agent or agent (e.g., an acid such as citric acid, nitric acid, or otherwise) for inducing a reaction that releases gas.

Preferably, the content of blowing agent, preferably azodicarbonamide, is less than 3.5 wt.-%, preferably at most 3.3 wt.-%, still more preferably at most 3.1 wt.-%, yet more preferably at most 2.9 wt.-%, even more preferably at most 2.8 wt.-%, most preferably at most 2.7 wt.-%, in each case relative to the total weight of the composition.

Preferably, the content of blowing agent, preferably azodicarbonamide, is more than 2.60 wt.-%, relative to the total weight of the composition.

When the curable and preferably pumpable polymer composition according to the invention is expandable, it may preferably comprise blowing agent accelerator. When the blowing agent accelerator comprises more than a single blowing agent accelerator, e.g. two different blowing agent accelerators, unless expressly stated otherwise, all amounts refer to the total content of all blowing agent accelerators that are encompassed by the blowing agent accelerator.

Preferably, the blowing agent accelerator comprises or essentially consists of zinc oxide.

Preferably, the content of blowing agent accelerator, preferably zinc oxide, is less than 3.5 wt.-%, preferably at most 3.3 wt.-%, still more preferably at most 3.1 wt.-%, yet more preferably at most 2.9 wt.-%, even more preferably at most 2.5 wt.-%, most preferably at most 2.2 wt.-%, in each case relative to the total weight of the composition.

In preferred embodiments, the composition according to the invention is expandable to a volume of at least 150 vol.-%, preferably at least 200 vol.-%, more preferably at least 250 vol.-%, still more preferably at least 300 vol.-% of its original volume. The degree of volume expansion can be tailored by the amount of blowing agent that is contained in the composition. Suitable amounts can be deter-mined by routine experimentation.

In preferred embodiments, the composition according to the invention expands at elevated temperature (activation temperature), preferably at a temperature of at least at least 110° C., more preferably at least 120° C., still more preferably at least 130° C., yet more preferably at least 140° C., even more preferably at least 150° C., most preferably at least 160° C., and in particular at least 170° C.

In preferred embodiments, the composition according to the invention expands at elevated temperature (activation temperature), preferably at a temperature of at most 200° C., more preferably at most 195° C., still more preferably at most 190° C., yet more preferably at most 185° C., even more preferably at most 180° C., most preferably at most 175° C., and in particular at most 170° C.

The curable and preferably pumpable polymer composition according to the invention preferably comprises rheology modifier. When the rheology modifier comprises more than a single rheology modifier, e.g. two different rheology modifiers, unless expressly stated otherwise, all amounts refer to the total content of all rheology modifiers that are encompassed by the rheology modifier.

Preferably, the rheology modifier comprises or essentially consist of one or more thixotropic rheology modifiers.

Preferably, the rheology modifier comprises or essentially consists of one or more silicates; more preferably one or more phyllosilicates; still more preferably one or more organophilic phyllosili-cates.

Phyllosilicates (sheet silicates) are minerals of a class of polymeric silicates in which the silicon-oxygen tetrahedral groups are linked by sharing three of every four oxygen atoms so as to form sheets of indefinite extent, in which the ratio of silicon to oxygen is 2:5, and in which some silicon atoms may be replaced by aluminum (as in mica, chlorite, kaolinite, montmorillonite, hectorite, saponite, fluoro-hactorite, laponite, magatiide).

In preferred embodiments, the phyllosilicates are independently selected from the group con-sisting of organophilic phyllosilicates, hydrophilic synthetic phyllosilicates, hydrophilic organophyllo-silicates, natural phyllosilicates, natural phyllosilicates intercalated with a modifier, e.g. an alkylonium ion having reactive moiety (cf. e.g. US 2004 0214921 A1, US 2007 0191527 A1, both incorporated by reference).

Organophilic phyllosilicates are known to the skilled person and commercially available. For example, montmorillonite consists of an octahedral sheet of alumina sandwiched between two opposing tetrahedral sheets of silica, negatively charged due to isomorphic substitution of a part of Al³⁺ by divalent cations such as Fe²⁺ or Mg²⁺. The isomorphic substitution within the layers generates negative charges that are counterbalanced by alkaline or alkaline earth cations situated in the interlayer. In order to render these hydrophilic phyllosilicates more organophilic, the hydrated cations of the interlayer can be ex-changed with cationic surfactant such as alkyl-ammonium ions or imidazolium ions. The thus modified phyllosilicates are organophilic and therefore more compatible with organic polymers. For details, ref-erence is made to e.g. S. Benali et al., Chapter 5: PCL/Clay Nano-Biocomposites, in L. Avdrous et al., Environmental Silicate Nano-Biocomposites, Springer 2012.

Suitable rheology modifier, preferably phyllosilicates, e.g. organophilic phyllosilicates, are commercially available, e.g. as Garamite® 1958.

Preferably, the content rheology modifier, preferably one or more phyllosilicates, is less than 6.0 wt.-%, preferably at most 5.5 wt.-%, still more preferably at most 5.0 wt.-%, yet more preferably at most 4.5 wt.-%, even more preferably at most 4.0 wt.-%, most preferably at most 3.5 wt.-%, in each case relative to the total weight of the composition.

The curable and preferably pumpable polymer composition according to the invention preferably comprises radical polymerization initiator. When the radical polymerization initiator comprises more than a single radical polymerization initiator, e.g. two different radical polymerization initiators, unless expressly stated otherwise, all amounts refer to the total content of all radical polymerization initiators that are encompassed by the radical polymerization initiator.

Preferably, the radical polymerization initiator comprises or essentially consists of one or more organic peroxides.

Preferably, the radical polymerization initiator comprises or essentially consist of
(i) a first organic peroxide selected from dibenzoyl peroxide; and
(ii) a second organic peroxide selected from 1,1′-di(tert-butylperoxy)-3,3,5-trimethylcyclohexane per-oxide.

Preferably, the radical polymerization initiator comprises dibenzoyl peroxide, wherein the content of dibenzoyl peroxide is less than 0.35 wt.-%, relative to the total weight of the composition.

Preferably, the radical polymerization initiator comprises dibenzoyl peroxide, wherein the content of dibenzoyl peroxide is more than 0.20 wt.-%, preferably at least 0.25 wt.-%, more preferably at least 0.30 wt.-%, still more preferably at least 0.35 wt.-%, in each case relative to the total weight of the composition.

The curable and preferably pumpable polymer composition according to the invention preferably comprises filler. When the radical polymerization initiator comprises more than a single filler, e.g. two different fillers, unless expressly stated otherwise, all amounts refer to the total content of all fillers that are encompassed by the filler. Examples of fillers include one or more of a metallic oxide, graphite (e.g., graphite flakes), a clay, a silicon-containing compound other than a phyllosilicate, an aramid pulp, or the like).

Preferably, the filler comprises or essentially consists of calcium carbonate.

Preferably, the content of filler, preferably calcium carbonate, is more than 16.60 wt.-%, relative to the total weight of the composition.

Preferably, the content of filler, preferably calcium carbonate, is at least 12 wt.-%, preferably at least 13 wt.-%, more preferably at least 14 wt.-%, still more preferably at least 15 wt.-%, yet more preferably at least 16 wt.-%, even more preferably at least 16.5 wt.-%, most preferably more than 16.6 wt.-%, in each case relative to the total weight of the composition.

The curable and preferably pumpable polymer composition according to the invention preferably comprises coloring agent. When the coloring agent comprises more than a single coloring agent, e.g. two different coloring agents, unless expressly stated otherwise, all amounts refer to the total content of all coloring agents that are encompassed by the coloring agent.

The curable and preferably pumpable polymer composition according to the invention may con-tain glass beads.

In preferred embodiments, the composition according to the invention does not contain a silane coated amorphous silica; preferably which does not contain any amorphous silica.

The composition according to the invention may or may not contain epoxy resin. In preferred embodiments of the composition according to the invention, the content of epoxy resin is at most 10 wt.-%, preferably at most 7.5 wt.-%, in each case relative to the total weight of the composition.

In preferred embodiments, the composition according to the invention is dry to the touch and/or non-tacky at room temperature (23° C.).

In other preferred embodiments, the composition according to the invention is tacky at room temperature (23° C.).

In preferred embodiments, the composition according to the invention is a one component composition. However, two component systems are also contemplated in accordance with the invention.

In preferred embodiments, the composition according to the invention has sufficient viscoelas-ticity and does not crunch when it is processed.

The composition according to the invention can preferably be deposited onto a surface of an article, preferably a vehicle component, by extrusion at ambient temperature (extrusion temperature, e.g. about 23° C.) or at an elevated temperature (extrusion temperature, e.g. up to about 120° C.) without premature curing. The article can have ambient temperature or elevated temperature (substrate temperature). The surface of the article can be clean, oily or may carry some other contaminant. It is envisioned that the composition may interact with the oil or other contaminant by reacting with it, by dissolving it, and/or by displacing it (e.g., the contaminant or any moiety or other portion thereof becomes assimilated physically and/or chemically into the composition).

In preferred embodiments, the composition according to the invention is not a paste, but a solid (typically at room temperature, i.e. 23° C.). Preferably, the composition according to the invention is pelletizable, i.e. can be provided in form of pellets and can be processed in form of pellets at room temperature (i.e. 23° C.).

Direct processing of pellets has some advantages compared to direct processing of a paste-like material, because after application and cooling to ambient temperature, the material applied by direct processing of pellets becomes a solid, whereas a material that is paste-like at ambient temperature does not solidify.

Prior to application, the composition according to the invention is then preferably heated to an elevated intermediate temperature at which the composition becomes a paste having a flowable viscosity such that it is pumpable at said elevated intermediate temperature but neither prematurely cures nor expands. Thus, the elevated intermediate temperature is preferably below the curing temperature and below the activation temperature of the optionally present blowing agent. After application the composition may then be cooled again, or further heated to a higher temperature exceeding the curing temperature and optionally the activation temperature of the optionally present blowing agent in order to induce curing and optionally expansion.

In other preferred embodiments, the composition according to the invention is a paste (typically at room temperature, i.e. 23° C.).

At a temperature of 15° C., the composition according to the invention is preferably a paste having a flowable viscosity such that it is pumpable. Preferably, at a temperature of 15° C., the viscosity of the composition according to the invention is at most 800 Pa·s, more preferably at most 700 Pa·s, still more preferably at most 600 Pa·s, yet more preferably at most 500 Pa·s, even more preferably at most 400 Pa·s, most preferably at most 300 Pa·s, and in particular at most 200 Pa·s. In preferred embodiments, at a temperature of 15° C., the viscosity of the composition according to the invention is within the range of from 200 to 800 Pa·s, more preferably from 250 to 400 Pa·s.

At a temperature of 60° C., the viscosity of the composition according to the invention is preferably at least 5 Pa·s, more preferably at least 7 Pa·s, still more preferably at least 9 Pa·s, yet more preferably at least 11 Pa·s, even more preferably at least 13 Pa·s. most preferably at least 15 Pa·s, and in particular at least 17 Pa·s. In preferred embodiments, at a temperature of 60° C., the viscosity of the composition according to the invention is within the range of from 5 to 20 Pa·s.

The characteristic “pumpable” of the composition according to the invention is preferably un-derstood such that at ambient temperature (i.e. 23° C.) the composition has a viscosity which is suitable for pumping and preferably has a paste-like viscosity. The viscosity of the composition is usually in the range of 50 to 500 Pa·s, when measured at 20° C. and a sheer rate of 430 sec⁻¹.

Preferably, at ambient temperature (i.e. 23° C.) the composition according to the invention has a viscosity at 20 s⁻¹ of from 280 to 420 Pa·s.

In preferred embodiments, the composition according to the invention has a relatively sharp decrease of viscosity when the composition is heated to an elevated intermediate temperature.

Preferably, the composition according to the invention can be heated to a first elevated intermediate temperature T₁ and to a second elevated intermediate temperature T₂ which is 40° C. higher than T₁ (i.e. T₂=T₁+40° C.); wherein T₂ and preferably also T₁ is above room temperature (i.e. 23° C.); wherein T₁ and T₂ are both below the curing temperature and below the activation temperature of the optionally present blowing agent; wherein at T₁ the composition has a viscosity ν₁; and wherein at T₂ the composition has a viscosity ν₂; wherein the viscosity ratio ν₁:ν₂ is at least 5, preferably at least 10, more preferably at least 15, still more preferably at least 20, yet more preferably at least 25, even more preferably at least 30, most preferably at least 35, and in particular at least 40. In preferred embodiments, T₂ is 50° C., or 60° C., or 70° C., or 80° C., or 90° C., or 100° C., or 110° C.

Preferably, the composition according to the invention can be heated to a first elevated intermediate temperature T₁ and to a second elevated intermediate temperature T₂ which is 30° C. higher than T₁ (i.e. T₂=T₁+30° C.); wherein T₂ and preferably also T₁ is above room temperature (i.e. 23° C.); wherein T₁ and T₂ are both below the curing temperature and below the activation temperature of the optionally present blowing agent; wherein at T₁ the composition has a viscosity vi; and wherein at T₂ the composition has a viscosity ν₂; wherein the viscosity ratio ν₁:ν₂ is at least 5, preferably at least 10, more preferably at least 15, still more preferably at least 20, yet more preferably at least 25, even more preferably at least 30, most preferably at least 35, and in particular at least 40. In preferred embodiments, T₂ is 50° C., or 60° C., or 70° C., or 80° C., or 90° C., or 100° C., or 110° C.

Preferably, the composition according to the invention can be heated to a first elevated intermediate temperature T₁ and to a second elevated intermediate temperature T₂ which is 20° C. higher than T₁ (i.e. T₂=T₁+20° C.); wherein T₂ and preferably also T₁ is above room temperature (i.e. 23° C.); wherein T₁ and T₂ are both below the curing temperature and below the activation temperature of the optionally present blowing agent; wherein at T₁ the composition has a viscosity vi; and wherein at T₂ the composition has a viscosity ν₂; wherein the viscosity ratio ν₁:ν₂ is at least 5, preferably at least 10, more preferably at least 15, still more preferably at least 20, yet more preferably at least 25, even more preferably at least 30, most preferably at least 35, and in particular at least 40. In preferred embodiments, T₂ is 50° C., or 60° C., or 70° C., or 80° C., or 90° C., or 100° C., or 110° C.

Preferably, the composition according to the invention can be heated to a first elevated intermediate temperature T₁ and to a second elevated intermediate temperature T₂ which is 10° C. higher than T₁ (i.e. T₂=T₁+10° C.); wherein T₂ and preferably also T₁ is above room temperature (i.e. 23° C.); wherein T₁ and T₂ are both below the curing temperature and below the activation temperature of the optionally present blowing agent; wherein at T₁ the composition has a viscosity vi; and wherein at T₂ the composition has a viscosity ν₂; wherein the viscosity ratio ν₁:ν₂ is at least 5, preferably at least 10, more preferably at least 15, still more preferably at least 20, yet more preferably at least 25, even more preferably at least 30, most preferably at least 35, and in particular at least 40. In preferred embodiments, T₂ is 50° C., or 60° C., or 70° C., or 80° C., or 90° C., or 100° C., or 110° C.

Methods for determining the viscosity of adhesive materials at various temperatures are known to the skilled person. Viscosity is typically measured by means of a rotational viscosimeter, preferably in accordance with ASTM D2196 or ASTM D2556.

It has been found that by combining liquid constituents of known viscosity and a rheology modifier, preferably one or more phyllosilicates, in a proper ratio, the wash-off resistance of the curable polymer composition according to the invention can be improved while maintaining its rheological requirements for pumpability at low temperatures. The curable polymer composition according to the invention may include liquids and solids, wherein the resulting curable polymer composition preferably has a viscosity that meets the rheology characteristic of being pumpable at temperatures of down to 15° C. In general, one or more other optional liquid constituents or reactive diluents may be used in an amount effective to lower the viscosity of the curable polymer composition to the desired level.

Reactive diluents may also be advantageous with respect to applicability of the curable polymer composition according to the invention onto oily surfaces. It has been found that reactive diluents may be helpful with regard to solubilization of oil that contaminates e.g. the surface of an element of a vehicle.

Concepts for dealing with oily surfaces or otherwise contaminated surfaces in principle may rely upon
displacement of the oil or contaminant, e.g. treatment of the surface prior to application of the composition by mechanical means (e.g. grinding), by flame, by plasma, by corona, and the like;
chemical modification of the oil or contaminant (e.g. by oxidation or reaction with functional groups such as carboxylic groups, amine groups, and the like); or
solubilization of the oil or contaminant (e.g. in liquid constituents such as reactive diluents).

Chemical modification of the oil or contaminant, e.g. by oxidation, may be achieved either by heating the oil or contaminant, or by heating the material on the surface of which the oil or contaminant is present.

In preferred embodiments, the composition according to the invention does not require displacement of the oil or contaminant prior to application, nor does it require heating the oil or contaminant or heating the material on the surface of which the oil or contaminant is present. Compatibility with oily or otherwise contaminated surfaces is preferably achieved by means of the ingredients that are contained in the composition according to the invention, preferably by means of one or more reactive diluents, and/or by one or more alternative or additional constituents that are preferably liquid in their neat state and that may contribute to the solubilization of oil or contaminants.

Preferred reactive diluents may be divided into epoxy-containing diluents on the one hand and compounds which derive their reactivity from functional groups other than epoxide on the other hand (non-epoxy based reactive diluents).

Preferred epoxy-containing reactive diluents (epoxy-based reactive diluents) may be subdivided into mono-epoxy compounds and di/polyfunctional epoxies. With both classes the presence of the epoxy group(s) allows the diluent to participate, with the resin and curing agent, in the polymerization and cross-linking reaction. The diluent thus becomes chemically bound into the cross-linked network.

Preferred mono-, di- or polyfunctional epoxy reactive diluents according to the invention include but are not limited to
(i) oxides of unsaturated, branched or unbranched, cyclic or open chain, aliphatic or aromatic C₄-C₃₀ hydrocarbons, e.g. octylene oxide, butadiene dioxide, epoxidized cyclohexenyl compounds, al-locimene dioxide, limonene dioxide, vinyl cyclohexane dioxide, styrene oxide, divinylbenzene dioxide, etc.;
(ii) glycidyl ethers of monohydric saturated or unsaturated, branched or unbranched, cyclic or open-chain C₄-C₃₀ alcohols, e.g. butanol glycidyl ether, hexanol glycidyl ether, 2-ethylhexanol glycidyl ether, allyl glycidyl ether, tetrahydrofurfuryl glycidyl ether, and furfuryl glycidyl ether, tri-methoxysilyl glycidyl ether, etc.;
(iii) glycidyl ethers of dihydric saturated or unsaturated, branched or unbranched, cyclic or open-chain C₂-C₃₀ alcohols, e.g. ethylene glycol glycidyl ether, butanediol glycidyl ether, hexanediol glycidyl ether, octanediol glycidyl ether, diethylene glycol diglycidyl ether, cyclohexane dimethanol diglycidyl ether, neopentyl glycol diglycidyl ether, etc.;
(iv) glycidyl ethers of tri- or polyhydric, saturated or unsaturated, branched or unbranched, cyclic or open chain alcohols, e.g. epoxidized castor oil, epoxidized trimethylolpropane, triglycidyl ether of trimethylolpropane, epoxidized pentaerythritol, or polyglycidyl ethers of aliphatic polyols, such as sorbitol, glycerol, trimethylolpropane, diglycidyl ether of cyclohexane dimethanol (e.g. Epodil® 757), etc.;
(v) glycidyl ethers of phenol compounds and of aniline compounds, e.g. phenyl glycidyl ether, mono glycidyl ethers of alkyl- and alkenyl-substituted phenols, cresyl glycidyl ether, diglycidyl ether of resorcinol, p-tert-butylphenyl glycidyl ether, nonylphenol glycidyl ether, 3-n-pentadecenyl-glycidyl ether (from cashew nut shell oil), epoxidized cashew nut shell liquid (CNSL, e.g. carda-nol, cardol and/or methylcardol, such as Cardolite® NC-514 or Cardolite® Lite 2513 HP), N,N-diglycidyl aniline, etc.;
(vi) epoxidized amines, such as N,N-diglycidyl cyclohexyl amine, etc.;
(vii) epoxidized mono- or dicarboxylic acids, e.g. glycidyl neodecanoate (e.g. Erisys® GS-110), glycidyl methacrylate, glycidyl benzoate, diglycidyl phthalate, diglycidyl tetrahydrophthalate, diglycidyl hexahydrophthalate, glycidyl ester of tert-carboxylic acids, diglycidyl esters of dimeric fatty acids, etc.;
(viii) epoxidized di- or trihydric, low- to high-molecular-weight polyether polyols, e.g. polyethylene glycol diglycidyl ether, polypropylene glycol diglycidyl ether, etc.

Preferred non-epoxy based reactive diluents include but are not limited to triphenyl phosphite, lactone compounds such as butyrolactone, hydroxy dioxane, limonene, tetrahydrofuran, furfuryl alco-hol, mesityl oxide, etc.

The composition according to the invention may contain additional ingredients such as thermoplastic polymers, elastomers, and the like.

In preferred embodiments, the composition comprises a polyvinylchloride (PVC), e.g. a polyvinylchloride homo- or a copolymer. If the polyvinylchloride is a copolymer it preferably comprises vinyl esters such as vinyl acetate or vinyl propionate as the comonomer to vinylchloride. The amount of the co-monomer typically ranges from about 1 to about 20 wt.-%, more typically is in the range of from 2 to about 10 wt.-%, and most preferably about 5 wt.-%, relative to the total weight of the copolymer.

In preferred embodiments, the composition according to the invention comprises an acrylic resin powder, which is solid at ambient temperature (23° C.). Preferably, the acrylic resin powder has a glass transition temperature Tg in the range of 50° C. to 120° C. and even more preferably in the range of 70° C. to 90° C. The glass transition temperature is determined by DSC. In addition, it is preferred that the acrylic resin powder is capable of forming a plastisol. The acrylic resin in the acrylic resin powder may be a homopolymer or a copolymer. A preferred acrylic resin is a resin based on methylmethacrylate.

In preferred embodiments, the composition according to the invention comprises a rubber, in particular a synthetic rubber and preferably a partially crosslinked synthetic rubber. Exemplarily partially crosslinked rubbers include but are not limited to diene rubbers, such as, e.g., acrylonitrile-isoprene copolymer rubber (NIR), acrylonitrile-butadiene copolymer rubber (NBR), styrene-butadiene copolymer rubber (SBR), a butadiene rubber (BR) and isoprene rubber (IR). The crosslinking may be the results of the addition of a crosslinking agent, such as divinyl benzene or sulfur. The addition of a rubber provides the advantages of improved rheological properties, sag resistance, wash-off resistance and a higher volume expansion of the resulting filler composition. The rubber is typically incorporated in amounts of from 1 to 20 wt.-%, preferably 3 to 15 wt.-% and more preferably 5 to 10 wt.-%, relative to the total weight of the composition.

In preferred embodiments, the composition according to the invention comprises a plastizicer. Preferred plasticizers are, for example, phthalate esters such as di(2-ethylhexyl)phthalate, butyl benzyl phthalate, dinonyl phthalate, diisononyl phthalate (DIDP), diisodecyl phthalate (DIDP), diundecyl phthalate, ditridecyl phthalate (DTDP), diheptyl phthalate and butylphthalyl butylglycolate; aliphatic dibasic acid esters such as dioctyl adipate, didecyl adipate and dioctysebacate; polyglycolbenzoic acid esters such as polyoxyethylene glycol dibenzoate and polyoxypropylene glycol dibenzoate; phosphate esters such as tributylphosphate and tricresylphosphate; hydrocarbons such as alkyl-substituted diphe-nyl, alkyl-substituted terphenyl, partially hydrogenated terphenyl, aromatic processing oil and pile oil. These plasticizers may be used singly or as a mixture of two or more kinds thereof. A suitable amount of plasticizer is from 5 to 40 wt.-%, preferably from 8 to 30 wt.-%, and in particular 10 to 20 wt.-%, relative to the total weight of the composition.

Following deposition, the composition according to the invention can preferably be bathed in a liquid coating fluid, preferably an electrocoating bath, without being washed off.

For the purpose of the specification, the terms “wash-off” and “wash-out” are used synony-mously.

Preferably, the composition according to the invention passes a wash-off test involving the following steps:
(a) a bead of the composition is applied on the surface of a stainless steel specimen (preferably a hot dip galvanized steel panel (DX54D+Z100, 200×40 mm)) having an oil load of 1.5 g/m² (preferably PL3802-39S, 1.5 g/m²=0.12 g), wherein the steel panel is used as substrate (base panel) without counter substrate (top panel);
(b) without precuring, the thus prepared sample is placed in an immersion jig and dropped unimpeded from a height of 20 cm into a tank filled with pure water at room temperature (23° C.);
(c) the sample is mounted to a stirrer in a second tank filled with pure water preheated to 55° C.;
(d) the sample is stirred for 3 minutes at a velocity of 60 rpm (0.82 m/s);
(e) the sample is removed and visually inspected, wherein the adhesive composition passes the wash-off resistance test when no significant changes to the adhesive composition are detected.

Preferably, the composition according to the invention passes a wash-off test in accordance with BMW standard AA-0044 from January 2018. The test is similar to the above test but test conditions are harsher: 60° C. instead of 55° C., and 140 rpm (1.47 m/s) instead of 60 rpm (0.82 m/s). Thus, the wash-off test preferably involves the following steps:
(a) a bead of the composition is applied on the surface of a stainless steel specimen (preferably a hot dip galvanized steel panel (DX54D+Z100, 200×40 mm)) having an oil load of 1.5 g/m² (preferably PL3802-39S, 1.5 g/m²=0.12 g), wherein the steel panel is used as substrate (base panel) without counter substrate (top panel);
(b) without precuring, the thus prepared sample is placed in an immersion jig and dropped unimpeded from a height of 20 cm into a tank filled with pure water at room temperature (23° C.);
(c) the sample is mounted to a stirrer in a second tank filled with pure water preheated to 60° C.;
(d) the sample is stirred for 3 minutes at a velocity of 140 rpm (1.47 m/s);
(e) the sample is removed and visually inspected, wherein the adhesive composition passes the wash-off resistance test when no significant changes to the adhesive composition are detected.

Due to the wash-off resistance, the composition is compatible with the electrocoat process that is commonly used in the manufacture of various vehicles.

In further preferred embodiments, the composition according to the invention passes the Wash-off Resistance Test for Adhesives and Sealers, GMW16700, preferably in the 2nd edition, February 2017, according to General Motors.

In further preferred embodiments, the composition according to the invention passes the Methods of Tests for Automotive-Type Sealers, Adhesives, and Deadeners (STABILIZED January 2021) J243_202101, ADS-5—Wash-Off Resistance Test according to SAE International.

In preferred embodiments, the composition according to the invention is heat activatable for curing and optionally expanding. Following bathing, the composition according to the invention can preferably be activated for curing by an external stimulus, preferably at elevated temperature above the curing temperature and optionally above the activation temperature of the optionally present blowing agent.

Preferably, the composition according to the invention provides excellent weatherability and does not show bond-line read-through. That is, after application and curing, distortions of a substrate that are visible to a naked eye, like a metal sheet over a cured adhesive bond-line will be avoided. For example, the composition as employed in automotive vehicle can withstand repeated (e.g., at least 100 cycles over a period of at least 100 hours) thermal cycling over time (e.g., between temperatures of −40° C. and 125° C.) without resulting in any such distortion.

Another aspect of the invention relates to an automotive vehicle assembly comprising:
a vehicle component and
an extruded bead of a curable and preferably pumpable polymer composition according to the invention as described above on a surface of the vehicle component.

For the purpose of the specification, the term “bead” encompasses any geometries, e.g. pellets, globules, spheres, squares, rectangles, strands, and the like. The cross-section of the bead may have any geometry, e.g. circular, oval, rectangular, triangular, rhombic, trapezoid, and the like.

The die used for extrusion may likewise have any geometry, e.g. circular, oval, rectangular, triangular, rhombic, trapezoid, and the like.

Preferably, the extruded bead resists one or more of the wash-off tests as described above.

Preferably, the extruded bead exhibits resiliency in response to loads encountered during manufacturing operations.

The surface of the article on which the composition is applied is preferably a vehicle component.

The vehicle is not particularly limited and includes automobiles such as automobiles with combustion engine or electrified automobiles, other electrified vehicles, railway vehicles, and the like.

Preferably, the vehicle component is selected from the group consisting of vehicle bonnet, vehicle roof, roof bow, vehicle door, door beam, tubular frame member, vehicle bumper, front fender baffle, vehicle sill, vehicle pillar such as A pillar (preferably lower or upper outer section thereof) or B pillar (preferably lower or upper outer section thereof), pillar closure vehicle suspension component, vehicle support member, side impact beam, reinforcement bar, vehicle skin, vehicle hood, vehicle trunk, rear lamp, fuel filler, battery housing, battery support, or any combination thereof.

The composition according to the invention is also useful as hem flange adhesive.

The composition according to the invention may be applied to substrates essentially requiring
2D applications (e.g. door beams, roof bows, simple linear geometries),
intermediate 3D applications (e.g. small to medium complex 3D geometries, fender baffles), or
large 3D applications (e.g. hood supports, fender baffles, door inners).

In preferred embodiments, the extruded bead (which may be applied as a single continuous strip or as a plurality of intermittently spaced apart strips) has
(i) an extrusion axis in the direction of motion of the die relative to a substrate upon which the bead is applied;
(ii) an average cross-sectional area (measured in a section taken orthogonally from the extrusion axis) of at least 0.1 cm², preferably at least 1.0 cm², more preferably at least 2.0 cm²; and at most 10 cm², preferably at most 8.0 cm², more preferably at most 6.0 cm², and still more preferably at most 4.0 cm²;
(iii) a cross-sectional profile along the extrusion axis that is circular, elliptical, hemispherical, rectangular, polygonal, having a plurality of lobes, or any combination thereof, and/or
(iv) a length of at least 1.0 cm, preferably at least 5.0 cm, more preferably at least 10 cm, and still more preferably at least 20 cm; and at most 1000 cm, preferably at most 750 cm, more preferably at most 500 cm, still more preferably at most 300 cm, and yet more preferably at most 100 cm; and/or
(v) a largest dimension across the cross-sectional profile (e.g., a width, a diameter, or otherwise) of at most 20 cm, preferably at most 10 cm, more preferably at most 5 cm, and still more preferably at most 2 or 1 cm; and/or a smallest dimension across the cross-sectional profile of most 5 cm, preferably at most 3 cm, more preferably at most 1 cm, and still more preferably at most 0.5 or 0.1 cm.

In preferred embodiments, the bead forms a closed loop, whereas loop closure is preferably achieved by applying one end of the bead to the other end of the bead in an overlapping manner.

The bead may have any shape such as a linear or a curved shape.

The dimensions of the bead may vary along its length. For example, the height and/or width may increase along its length.

In preferred embodiments, the bead fills a gap having maximum length L, maximum width W and maximum depth D, wherein (i) L>W>D or (ii) L>D>W or (iii) L>D=W.

In preferred embodiments, the bead fills a gap between two substrates to be adhered to one another, preferably the surface of the vehicle component and the surface of the counter substrate. Preferably, the gap between the two substrates at least in a local region is 70 mm or less, preferably 50 mm or less, and more preferably 20 mm or less; preferably at most 18 mm, more preferably at most 16 mm, still more preferably at most 14 mm, yet more preferably at most 12 mm, even more preferably at most 10 mm, most preferably at most 8 mm, and in particular at most 6 mm.

In preferred embodiments, the automotive vehicle assembly comprises multiple layers of beads, preferably extruded on top of each other. Preferably, the automotive vehicle assembly comprises two layers of beads, three layers of beads, four layers of beads, five layers of beads, six layers of beads, or seven layers of beads.

Another aspect of the invention relates to a method of producing the automotive vehicle assembly according to the invention as described above, the method comprising the steps of
(a) providing the vehicle component having a surface (e.g., external and/or internal); and
(b) extruding a bead of the curable polymer composition through an extrusion device and directly onto the surface of the vehicle component (optionally the bead is extruded into a cavity defined by an internal surface of the component).

The components may have a wall that defines the surface onto which a bead of the composition is extruded. The wall may have an average thickness (e.g., below 1 cm, more preferably below 0.5 cm). The components may be sheet metal, cast metal, injection molded plastic, extruded plastic, pultruded plastic, a consolidated fibrous material in a polymeric matrix, or any combination thereof. Preferably, the temperature of the surface of the vehicle component is controlled.

Preferably, at the time of the bead contacting the surface of the vehicle component throughout the duration of extruding, the temperature of the surface of the vehicle component (substrate temperature) is at most 65° C., preferably at most 60° C., more preferably at most 55° C., still more preferably at most 50° C., yet more preferably at most 45° C., even more preferably at most 40° C., most preferably at most 35° C., and in particular at most 30° C.

Various temperatures can play an important role and it seems appropriate to distinguish at least the following temperatures:
(i) temperature of the composition according to the invention during step (b) (herein also referred to as “extrusion temperature”);
(ii) temperature of the vehicle component and its surface, respectively (herein also referred to as “substrate temperature”);
(iii) temperature of the automotive vehicle assembly after step (b) and prior to step (c) (see below) (herein also referred to as “no precuring temperature”);
(iv) temperature of liquid fluid(s) into which the automotive vehicle assembly is immersed (herein also referred to as “liquid temperature”);
(v) temperature at which the composition as part of the automotive vehicle assembly is finally cured (herein also referred to as “curing temperature”); and
(vi) optionally, when the composition contains a heat activatable blowing agent, temperature at which volume expansion by activation of the blowing agent is induced (herein also referred to as “activation temperature”).

Preferably, wherein the surface of the vehicle component provided in step (a) is oily.

Preferably, step (b) is performed robotically.

In preferred embodiments, in step (b) extrusion is performed at a temperature of the curable polymer composition (extrusion temperature) which is ambient temperature (e.g. 23° C.), i.e. the curable polymer composition is not actively heated for the purpose of extrusion.

In other preferred embodiments, in step (b) extrusion is performed at a temperature of the curable polymer composition (extrusion temperature) which is above ambient temperature (e.g. 23° C.), i.e. the curable polymer composition is actively heated for the purpose of extrusion.

Preferably, in step (b) extrusion is performed at a temperature of the curable polymer composition (extrusion temperature) of at most 65° C., preferably at most 60° C., more preferably at most 55° C., still more preferably at most 50° C., yet more preferably at most 45° C., even more preferably at most 40° C., most preferably at most 35° C., and in particular at most 30° C.

In preferred embodiments, step (b) comprises extruding multiple layers of beads, preferably on top of each other. Preferably, step (b) comprises the sub-steps of
(b1) extruding a bead of the curable polymer composition through an extrusion device and directly onto the surface of the vehicle component (optionally the bead is extruded into a cavity defined by an internal surface of the component);
(b2) extruding a second bead of the curable polymer composition through the extrusion device and directly onto the surface of the bead extruded directly onto the surface of the vehicle component;
(b3) optionally, extruding a third bead of the curable polymer composition through the extrusion device and directly onto the surface of the second bead;
(b4) optionally, extruding a fourth bead of the curable polymer composition through the extrusion device and directly onto the surface of the third bead; and
(b5) optionally, extruding a fifth bead of the curable polymer composition through the extrusion device and directly onto the surface of the fourth bead.

Step (b) may comprise further sub-steps analogous to steps (b2) to (b5) for extruding further beads, for example a sixth bead and a seventh bead. Thus, step (b) may comprise extruding multiple layers of beads on top of each other, for example two layers of beads, three layers of beads, four layers of beads, five layers of beads, six layers of beads, or seven layers of beads.

Preferably, the method comprises the additional step of
(c) immersing the vehicle component with the extruded bead on its surface in a bath of a liquid coating fluid, preferably an electrocoating bath.

Preferably, the temperature of the automotive vehicle assembly after the extruding in step (b) until the immersing in step (c) is independently maintained at a temperature of at most 65° C., preferably at most 60° C., more preferably at most 55° C., still more preferably at most 50° C., yet more preferably at most 45° C., even more preferably at most 40° C., most preferably at most 35° C., and in particular at most 30° C. (no precuring temperature). Said temperature of the automotive vehicle assembly after the extruding in step (b) until the immersing in step (c) may differ from the extrusion temperature and from the substrate temperature.

Preferably, the vehicle component with the extruded bead on its surface is immersed in carious baths including one or more of degreasing bath, phosphating bath, rinse bath, and e-coating bath.

Preferably, the method is free of any step of precuring (prebaking) the automotive vehicle assembly or the extruded bead of the curable polymer composition before immersing in step (c).

Preferably, the method is free of any step of applying a counter substrate to the automotive vehicle assembly or the extruded bead of the curable polymer composition before immersing in step (c).

Preferably, the method comprises the additional step of
(d) heating the automotive vehicle assembly or the extruded bead of the curable polymer composition to a temperature above the curing temperature of the curable polymer composition to induce curing; and optionally above the activation temperature of the optionally present blowing agent to induce volume expansion.

Preferably, in the course of step (d) the curable polymer composition on the surface of the vehicle component is adhered to the surface of a counter substrate. Preferably, in the course of step (d) the curable polymer composition on the surface of the vehicle component is expanded thereby coming into contact with the surface of the counter substrate. Preferably, prior to performing step (d), the gap between the surface of the vehicle component and the surface of the counter substrate at least in a local region is 70 mm or less, preferably 50 mm or less, and more preferably 20 mm or less; preferably at most 18 mm, more preferably at most 16 mm, still more preferably at most 14 mm, yet more preferably at most 12 mm, even more preferably at most 10 mm, most preferably at most 8 mm, and in particular at most 6 or even 4 mm.

Another aspect of the invention relates to the use of a curable and preferably pumpable polymer composition according to the invention as described above for producing an automotive vehicle assembly according to the invention as described above, preferably in a method according to the invention as described above.

In preferred embodiments, the curable and preferably pumpable polymer composition according to the invention is used at the junction between e.g. reinforcement bars and skins, doors, roof, hoods, or trunks. The applied uncured polymer composition will be wash-off resistant in subsequent treatment baths and e-coat treatment even when being applied onto the surface of a substrate without a counter substrate.

The curable and preferably pumpable polymer composition according to the invention is useful throughout a vehicle and services all body shop categories; crash resistant, structural, hemming and anti-flutter products. When being used for crash resistant bonding, the composition according to the invention contribute to a significant increase in energy absorption during crash events. Superior impact peel values and reduction of car body intrusion space provides effective bonding solution for high-performance vehicles. When being used for structural bonding, the composition according to the invention delivers several performance and process benefits, including increased car body stiffness, excellent oil absorption, wash-out resistance, long-term corrosion resistance, a substantial reduction in the number of spot weld points and long shelf life. When being used in anti-flutter and spot welding paste sealing applications, the composition according to the invention provides excellent adhesion to standard OEM steel and aluminum substrates. It offers vibration free panel isolation joining, while also protecting durable metals against age-related corrosion from the elements. It prevents bond-line-read-through (BLRT) and does not reduce the strength of welding spots. It can also be utilized as a spot weld paste adhesive.

The curable and preferably pumpable polymer composition according to the invention is useful for hem flanging.

Other teachings applicable in general to all embodiments, and in combination with each other, include the following.

A bead may be extruded onto a surface, and a carrier or other article may be applied in com-pression onto the bead (e.g., the bead, which may be an adhesive that does not contain any blowing agent and will not form a foam) is squeezed between two surfaces).

A component onto which a bead of the present teachings is applied may be a carrier for a structural reinforcement, for a baffle, or a combination thereof, and/or such component may also carry a second activatable material that differs in composition relative to the bead of the composition of the present invention.

A bead may be applied to opposing external surfaces of a carrier to result within an automotive vehicle in bonding two different components of the vehicle to the carrier. For example, opposing formed sheet metal sections that are welded together at joints to define a cavity may have a carrier located in the cavity, and (i) the adhesive of the invention bonds the carrier to each of the sheet metal sections; (ii) the sheet metal joints are bonded to the adhesive; and/or both (i) and (ii).

A bead may be applied to a carrier that has a plurality of cellular cavities defined thereof, the cellular cavities having a length, width and/or depth that is at least 1 cm, preferably at least 2 cm, and is less than 5 cm, and preferably is less than 3 cm. The cavities may be open and at least partially enclosed by three, four, five or six walls. The cells may be bounded by a plurality of generally flat side walls. The side walls defining the cells may connect with each other to define a polygon (e.g., a rectangle, a hexagon or otherwise). Walls defining any of the cells may include one or more through holes. The carrier may include one or more integrally formed fasteners (e.g., clips or other structures that will penetrate an opening in a vehicle component and interferingly secure the carrier to the component).

The following examples further illustrate the invention but are not to be construed as limiting its scope.

The following compositions according to the invention were manufactured by blending all ingredients with one another:

| | | melting | MI 190° C./ | | | | | |
|---|---|---|---|---|---|---|---|---|
| | | point | 2.16 kg [g/10 | | | | | |
| [g] | | [° C.] | min] | Ex. 1 | Ex. 2 | Ex. 3 | Ex. 4 | Ex. 5 |
| (i) | ethylene/butyl acrylate | 65 | 260-350 | 16.38 | 32.46 | 22.24 | 16.38 | 22.24 |
| | copolymer | 66 | 35-45 | 32.46 | 16.38 | 22.24 | 22.24 | 16.38 |
| | | sum | | 48.84 | 48.84 | 44.48 | 38.62 | 38.62 |
| (ii) | ethylene/vinyl acetate | 63 | 700-900 | 2.35 | 3.42 | 3.73 | 4.78 | 5.33 |
| | copolymer | 72 | 5.0-8.0 | 2.35 | 3.42 | 3.73 | 4.78 | 5.33 |
| | | 73 | 5.7 | | | | | |
| | | sum | | 4.7 | 6.84 | 7.46 | 9.56 | 10.66 |
| (iii) | n-butyl acrylate/glycidyl | 72 | 8 | 4.48 | 4.48 | 4.48 | 4.48 | 4.48 |
| | methacrylate/ethylene | | | | | | | |
| | terpolymer | | | | | | | |

| | | | | | | |
|---|---|---|---|---|---|---|
| | (i) + (ii) + (iii) sum | 58.02 | 60.16 | 56.42 | 52.66 | 53.76 |
| (iv) | hydrocarbon resin; polymerization product from un- | — | 12.43 | 15.92 | — | 12.43 |
| | saturated aromatic C9-/C10-hydrocarbons | | | | | |
| (v) | dipentaerythritol pentaacrylate | 1.19 | 1.19 | 1.19 | 1.19 | 1.19 |
| (vi) | azodicarbonamide | 2.65 | 2.65 | 2.65 | 2.65 | 2.65 |
| (vii) | organophilic phyllosilicates, rheology additive | — | — | 2.99 | 2.99 | 2.99 |
| (viii) | zinc oxide | 2.19 | 2.19 | 2.19 | 2.19 | 2.19 |
| (ix) | 1,1′-di(tert-butylperoxy)-3,3,5-trimethylcyclohexane | 1.19 | 1.19 | 1.19 | 1.19 | 1.19 |
| | peroxide 40% in calcium carbonate and silica | | | | | |
| | dibenzoyl peroxide 50% with dicyclohexylphthalate | 0.59 | 0.59 | 0.59 | 0.59 | 0.59 |
| (x) | calcium carbonate | 16.66 | 16.66 | 16.66 | 16.66 | 16.66 |
| (xi) | regular color opacifying and tinting carbon black | 0.20 | 0.20 | 0.20 | 0.20 | 0.20 |

1. A curable polymer composition for use as a sealant, an adhesive, a reinforcement, a dampener, and/or a sound absorber comprising:
(i) a first ethylene copolymer;
(ii) a second ethylene copolymer;
(iii) an ethylene terpolymer;
(iv) a tackifier;
(v) a curing agent;
(vi) optionally, a blowing agent; and
(vii) a rheology modifier;
wherein the composition optionally includes one or more of a blowing agent accelerator;
a polymerization initiator;
a filler; and
a coloring agent;
wherein the composition is optionally dry to the touch and non-tacky at 23° C.

2. The composition according to claim 1, wherein the rheology modifier comprises or essentially consists of one or more silicates; more preferably one or more phyllosilicates; still more preferably one or more organophilic phyllosilicates.

3. The composition according to claim 1, wherein the tackifier comprises one or more polymerization products from unsaturated aromatic C9-/C10-hydrocarbons.

4-6. (canceled)

7. The composition according to claim 1, wherein the content of tackifier, preferably one or more polymerization products from unsaturated aromatic C9-/C10-hydrocarbons, is less than 16 wt.-%, relative to the total weight of the composition.

8-14. (canceled)

15. The composition according to claim 1, wherein the radical polymerization initiator comprises dibenzoyl peroxide, wherein the content of dibenzoyl peroxide is less than 0.35 wt.-%, relative to the total weight of the composition.

16. The composition according to claim 1, wherein the content of filler, carbonate is more than 16.60 wt.-%, relative to the total weight of the composition.

17. (canceled)

18. The composition according to claim 16, which at 23° C. is a paste.

19. The composition according to claim 1, which is a one component composition.

20. The composition according to claim 1, which is heat activatable for curing and optionally expanding.

21. The composition according to claim 20 which expands and/or cures at elevated temperature of
at least at least 110° C., more preferably at least 120° C. and/or
at most 200° C.

22-29. (canceled)

30. The composition according to claim 1, wherein the first ethylene copolymer comprises a mixture of:
an ethylene/butyl acrylate copolymer A having a melt index according to ISO 1133 (190° C./2.16 kg) within the range of 300±275 g/10 min; and
an ethylene/butyl acrylate copolymer B having a melt index according to ISO 1133 (190° C./2.16 kg) within the range of 40±37.5 g/10 min.

31. The composition according to claim 1 wherein the first ethylene copolymer comprises a mixture of:
an ethylene/butyl acrylate copolymer A at a content within the range of 22.5±20.0 wt.-%, in each case relative to the total weight of the composition; and
an ethylene/butyl acrylate copolymer B at a content within the range of 22.5±20.0 wt.-%, in each case relative to the total weight of the composition.

32-50. (canceled)

51. The composition according to claim 1, wherein the radical polymerization initiator comprises:
(i) a first organic peroxide selected from dibenzoyl peroxide; and
(ii) a second organic peroxide selected from 1,1′-di(tert-butylperoxy)-3,3,5-trimethylcyclohexane peroxide.

52-53. (canceled)

54. The composition according to claim 1 which at a temperature of 15° C. is a paste having a flowable viscosity such that it pumpable.

55. (canceled)

56. The composition according claim 1, which at a temperature of 15° C. has a viscosity determined by means of a rotational viscosimeter within the range of from 200 to 800 Pa·s.

57. (canceled)

58. The composition according to claim 1, which can be heated to a first elevated intermediate temperature T₁ and to a second elevated intermediate temperature T₂ which is from 10° C. to 40° C. higher than T₁ (i.e. T₂=T₁+40° C.); wherein T₂ and preferably also T₁ is above room temperature (i.e. 23° C.); wherein T₁ and T₂ are both below the curing temperature and below the activation temperature of the optionally present blowing agent; wherein at T₁ the composition has a viscosity v₁; and wherein at T₂ the composition has a viscosity v₂; wherein the viscosity ratio v₁:v₂ is at least 5, preferably at least 10, more preferably at least 15, still more preferably at least 20, yet more preferably at least 25, even more preferably at least 30, most preferably at least 35, and in particular at least 40; wherein T₂ is 50° C., or 60° C., or 70° C., or 80° C., or 90° C., or 100° C., or 110° C.

59-62. (canceled)

63. The composition according to claim 58, which passes a wash-off test in accordance with BMW standard AA-0044 from January 2018; involving the following steps: (a) a bead of the composition is applied on the surface of a stainless steel specimen (preferably a hot dip galvanized steel panel (DX54D+Z100, 200×40 mm)) having an oil load of 1.5 g/m² (preferably PL3802-39S, 1.5 g/m²=0.12 g), wherein the steel panel is used as base panel without counter substrate (top panel); (b) without precuring, the thus prepared sample is placed in an immersion jig and dropped unimpeded from a height of 20 cm into a tank filled with pure water at room temperature (23° C.); (c) the sample is mounted to a stirrer in a second tank filled with pure water preheated to 60° C.; (d) the sample is stirred for 3 minutes at a velocity of 140 rpm (1.47 m/s); (e) the sample is removed and visually inspected, wherein the adhesive composition passes the wash-off resistance test when no significant changes to the adhesive composition are detected.

64. An automotive vehicle assembly comprising:
a vehicle component and
an extruded bead of a curable polymer composition according to claim 1 on a surface of the vehicle component.

65-68. (canceled)

69. The automotive vehicle assembly according to claim 64 wherein the extruded bead has
(i) an extrusion axis in the direction of motion of the die relative to a substrate upon which the bead is applied;
(ii) an average cross-sectional area (measured in a section taken orthogonally from the extrusion axis) of at least 0.1 cm², preferably at least 1.0 cm², more preferably at least 2.0 cm²; and at most 10 cm², preferably at most 8.0 cm², more preferably at most 6.0 cm², and still more preferably at most 4.0 cm²;
(iii) a cross-sectional profile along the extrusion axis that is circular, elliptical, hemispherical, rectangular, polygonal, having a plurality of lobes, or any combination thereof; and/or
(iv) a length of at least 1.0 cm, preferably at least 5.0 cm, more preferably at least 10 cm, and still more preferably at least 20 cm; and at most 1000 cm, preferably at most 750 cm, more preferably at most 500 cm, still more preferably at most 300 cm, and yet more preferably at most 100 cm.

70-88. (canceled)

89. A curable polymer composition for use as a sealant, an adhesive, a reinforcement, a dampener, and/or a sound absorber, wherein the composition can be deposited onto a surface of an article by extrusion at ambient temperature or at elevated temperature; wherein following deposition the composition can be bathed in a liquid coating fluid without being washed off; and wherein following bathing the composition can be activated for curing by an external stimulus; and wherein the composition is an epoxy-based material.
